(19) United States
(12) Patent Application Publication
(10) Pub. No.: US 2022/0003116 A1
(43) Pub. Date: Jan. 6, 2022

(54) IMPROVEMENTS RELATING TO UNDERGROUND MINING

(71) Applicant: BeWimo Pty Ltd, Beaconsfield, Victoria (AU)

(72) Inventors: Benjamin William MOORE, Beaconsfield (AU); Timothy Scott MASON, Victoria Park (AU)

(21) Appl. No.: 17/310,641

(22) PCT Filed: Feb. 14, 2020
(86) PCT No.: PCT/AU2020/050127

§ 371 Date: Aug. 13, 2021

(30) Foreign Application Priority Data
Feb. 15, 2019 (GB) 1902094.0

(51) Int. Cl. E21F 13/02; G05D 1/00; G05D 1/02

(52) U.S. Cl. CPC E21F 13/025; G05D 1/0038; G05D 2201/021; G05D 1/0246; G05D 1/0238

(57) ABSTRACT

The specification discloses a driverless haulage vehicle (10,32,43,44,45) for use within an underground mining operation including a unitary support chassis (11) having a first end section (15), a second end section (16) and a central section (50) located between said first and said second end sections (15,16), haulage vehicle transport means (51) including a first wheel assembly (52), associated with and supporting the first end section (15), a second wheel assembly (53) associated with and supporting said second end section (16) of the unitary support chassis (11), and a third wheel assembly (54) associated with and supporting the central section (50) of the unitary support chassis (11), steerage means (55) carried on said driverless haulage vehicle (10,32,43,44,45) for directing said vehicle along a transport path with an underground mine, the steerage means (55) including said first wheel assembly (52) and said second wheel assembly (53), said steerage means (55) further including a sensor set from which sensor data is generated representing internal status of the driverless haulage vehicle (10,32,43,44,45), and/or environmental status within which the driverless haulage vehicle (10,32,43,44,45) is operating, and controllable activators (27) to control steering movements of said first wheel assembly (52) and said second wheel assembly (53) whereby driving steering, wheels (13) of the first wheel assembly (52) are directed oppositely to wheels (13) of the second wheel assembly (53).

### FIELD OF THE INVENTION

The present invention relates to improvements associated with underground mining, for example, associated with improvements to vehicles and systems for underground mining particularly for extracting excavated materials from mines. The present invention also relates to improvements in underground mining processes.

### BACKGROUND TO THE INVENTION

Within the underground mining industry, the following problems are currently considered and addressed separately but not as a single entity. These problems include high cost of labour, excess fuel usage, process imbalance, unnecessary motion, uneven process, poor machine utilization and high ventilation costs. It is proposed to introduce novel solutions to provide an integrated response to the challenges of these problems. Inefficiencies are now being solved as individual problems without considering the complete process of hard rock extraction. Thus an inefficient batch process is the current norm.

Current underground haulage vehicles for extracting hard rock/earth excavated materials suffer from years of limited design changes and have not been significantly improved. This presents miners with at least some of the following issues:
Many underground hard rock mines have two sizes of tunnels, typically a “decline” usually measuring 5.5 m high and 5 m wide, and a “drive” usually measuring 5 m high and 4.5 m wide. In general, any haulage vehicle that has a payload of 30 tonnes or greater, cannot pass another vehicle of the same size on the decline causing traffic management issues and wasted time in waiting for another vehicle to pass whilst parked to the side. Most of these vehicles cannot fit a 5 m×4.5 m drive due to an inability to meet turning circle requirements, for example at 90° bends or corners. There is an additional issue of having to reverse into the drive to be loaded with excavation material located at the end of the drive which wastes time and requires unnecessary work.
On the return trip up the incline of the decline or drive, the haulage vehicle is loaded with ore and this inhibits performance of the vehicle. A decline often has a gradient of 1 m rise in 7 m in distance (approx. 8.1°). As these existing haulage vehicles have an inefficient drive train and design size restrictions, these machines frequently have a maximum loaded speed of 9-10 km/hr up the decline. As a result, there is an imbalance in time between going down the decline (approx. 20 km/hr) and going up the decline causing traffic management and process balance issues due to these speed differences. This can cause significantly increased usage of fuel by the haulage vehicle.
Underground hard rock mining haulage is a cyclic process which requires the repetitive task of drawing up and down the drive/decline. Often the distance travelled can be kilometers long and the vehicle needs a person operating it which results in excess cost and fatigue. One cycle on a 12 km drive/decline may take about 2 hours to complete.
The availability of current technology heavily influences the haulage process, for example, a decline is often designed to cater for the largest underground haulage trucks. This oversizing may even may even occur for a drive level. However this is inherently inefficient because the larger the tunnel, the more is the resulting development cost and time. Due to lack of optimal sized vehicles, miners are restricted to a process that promotes larger than ideal haulage vehicle to haul more tonnage thereby requiring a larger tunnel and commensurately higher development cost.
Load, haul and dump (“LHD”) vehicles are primarily used to transport ore within the drive level from the ore source to the decline. This journey can be hundreds of meters (or longer) and often cannot be accessed by haulage trucks. Vehicles go from the ore source to decline loaded, then return to the ore source unloaded. This process (called “tramming”), only adds value in one direction whilst the other direction uses unnecessary fuel, increases cycle time and requires double handling to load the haulage vehicle. In addition, the capacity of the LHD vehicle in much less than the haulage vehicle so it makes multiple trips back and forth to fill the haulage vehicle. Depending on the length of the drive, it can take up to half an hour to get 60 tonnes to the decline stock pile, from which, the haulage vehicle is loaded, thereby causing the aforementioned double handling.
An underground mine is an ecosystem that requires oxygen to be pumped through ventilation systems to sustain life within work areas of the mine. Often a ventilation system is combined with a cooling system to keep the mine at an operational temperature. These systems require electricity to function and run as high as 85% of designed capacity. Most of the effort required is to evacuate emissions created from vehicles in the mine, most of which comes from the haulage and LHD vehicles. Due to the nature of fluid dynamics through a duct, an increase in required air flow results in an exponential increase in energy used by the ventilation system. Any wasted energy within a process that results in unnecessary emissions has a direct exponential effect on the electricity used to power the ventilation system. Often ventilation ducting is located on the roof and must remain the same cross-sectional area otherwise it will interfere with moving equipment. The exponential curve is dependent on a mine's characteristics and it is common to see 8× more electricity used to run ventilation for 2× the emissions. Ventilation in drives is often only designed to provide enough ventilation for an LHD vehicle to operate within regulations therefore the haulage truck is not permitted to enter that area. Due to the current haulage vehicle technology which heavily influences the haulage process capability, much of the ventilation energy used is due to inferior vehicle design. Non value-added processes such as tramming and vehicle design issues are heavily contributing to the cost of ventilation.
An underground mine often has a quota to meet based on many external influences. One of the major contributors is the price of the ore being extracted which is result of supply and demand. Often underground mines keep up with demand by increasing the number of extraction related vehicles which run simultaneously to extract ore from multiple sources (stopes etc). All the issues previously mentioned are then multiplied depending on the required quota. Often multiple loading vehicles (LHDs) are running at once to fill multiple haulage vehicles, so the inefficiencies of the haulage process and ventilation due to the equipment design is exponentially affected.
A mining company is effectively a logistics company with all the inefficiencies of hauling a load from point A to B.

There is a gap between:
the following preferred aspects:
   maximising process efficiencies
   maximise energy usage efficiency
   maximise flexibility
and the following challenges:
   restricted process capability and access to parts of the mine
   excess processing and motion resulting in wasted energies
   excess work in progress and inventory
   uneven process balance
   inefficient systems and technology resulting excess fuel usage
   low kerb weight vs Payload ratio resulting excess fuel usage for value added
   requires human operation for a cyclic job
   overburden of ventilation and cooling system resulting in excess energy usage.

The more the ore extraction process can converge on a continuous process the more effective it will be in reducing incidental work and wasted effort. A conveyor is an example of a continuous process but applying this solution is often inflexible and expensive to install and run. Haulage trucks represent a fragmented conveyor but result in the issues previously stated due to archaic technology and minimal consideration of process optimisation.

### SUMMARY OF THE INVENTION

According to a first aspect of the present invention, there is provided a driverless haulage vehicle suitable for use with an underground mining operation. Conveniently, the driverless haulage vehicle can also be operated above ground but its advantages are achieved by not requiring one or more manual operators below ground.

According to a further aspect, the invention provides a driverless haulage vehicle for use with an underground mining operation, said vehicle including support and transport means including an electrically powered drivetrain, said electrically powered drivetrain having at least one electric motor. The drive train may include three sections, a first section being located towards a first end of the driverless haulage vehicle, a second section being located towards a second end of the driverless haulage vehicle opposite to said first end, and a central section being located between said first section and said second section. Conveniently, each said drive section is driven by at least one said electric motor.

According to yet another aspect, the invention also provides a driverless haulage vehicle for use with an underground mining operation, said vehicle including a unitary support chassis having a first end section, a second end section and a central section located between said first and said second end sections, haulage vehicle transport means including a first wheel assembly associated with and supporting the first end section, a second wheel assembly associated with and supporting said second end section of the unitary support chassis, and a third wheel assembly associated with and supporting the central section of the unitary support chassis, steerage means carried on said driverless haulage vehicle for directing said vehicle along a transport path with an underground mine, the steerage means including said first wheel assembly and said second wheel assembly, said steerage means further including a sensor set from which sensor data is generated representing internal status of the driverless haulage vehicle, and/or environmental status within which the driverless haulage vehicle is operating, and controllable actuators to control steering movements of said first wheel assembly and said second wheel assembly whereby during steering, wheels of the first wheel assembly are directed oppositely to wheels of the second wheel assembly.

Conveniently, the first wheel assembly includes a pair of laterally spaced ground contacting first wheel means, the first wheel means being independently steerably mounted to a first driven axle arrangement, said first wheel means being steerably mounted independent relative to each other. Conveniently, the second wheel assembly includes a pair of second wheel means being independently steerably mounted to a second driven axle arrangement, said second wheel means being steerably mounted independent relatively to each other.

One advantage associated with an autonomous vehicle is that it is not necessary to provide a cabin for a driver operator. Accordingly, the vehicle can be smaller than otherwise possible, allowing the space occupied by the vehicle to better dedicated to the purpose of haulage in an underground mining environment. As these vehicles can be relatively smaller, they are able to fit into the smaller, narrower tunnels that are normally inaccessible to traditional manned haulage vehicles. Accordingly, they are able to reduce tramming of LHD (load, haul and dump) vehicles that often shuttle back-and-forth along such smaller tunnels (e.g. drives) between an extremity of the mine where material is excavated, and a main larger tunnel (e.g. decline). In particular, the autonomous vehicle is able to drive right up to an excavation machine, potentially interfacing with it such that excavated material can be passed directly into the vehicle tub.

Additionally, as the vehicle is smaller, it is easier for this vehicle to pass other similarly constructed vehicles coming in the other direction, improving the flow of traffic and so the rate at which excavated material can be extracted from the mine.

To this end, optionally, the autonomous vehicle is no greater than 3 meters wide, no greater than 10 meters long, and/or no greater than 3 meters tall. More particularly, the vehicle may be typically between 2-3 m wide, 2-3 m tall, and 8-10 m long. Even more desirably the vehicle is no longer than 9.5 meters.

The vehicle may include, an electrically-powered drivetrain. The electrically-provided drivetrain may include three sections, a first section being located towards a first end of the vehicle, a second section being located at a second end of the vehicle, and a central section being located between the first and second sections. Each of the aforesaid sections may be driven by a respective motor, ideally an electric motor. Each of the aforesaid sections may be carried on a plurality of spaced wheels. Conveniently, a pair of spaced said wheels support each of said sections. Each of the aforesaid motors may be linked to the wheels of its respective section via a differential. Alternatively, motors may be linked to and separately drive individual wheels, for example each in the form of a “hub” motor. Preferably, the wheels of the first and second sections are movably mounted and are configurable in differing selectable steering positions by steering linkages. Preferably, the wheels of the first section are arranged to be movable, during a corner-turning operation or curved track operation in an opposite orientation to those of the second section. Advantageously, this can reduce the turning circle of the vehicle.

Naturally, the vehicle may be provided with an electrical power source such as one or more batteries. Generally, such electrical power sources are relatively heavy, and so it is preferred that they are situated close to the ground to lower the center of gravity of the vehicle. Nonetheless, a set of batteries may be located at a position on the vehicle allowing relatively straight-forward detachable attachment. Accordingly, the vehicle can be easily modified to have a higher battery capacity in circumstances where the vehicle needs a larger range. Moreover, the vehicle may be configured to undertake a battery exchange operation wherein a depleted vehicle battery is swapped for a fully-charged battery. This can occur at a battery charging station which may be located above ground, below ground or in multiple such locations. This can allow the vehicle to quickly “refuel”. The battery exchange operation may be automated.

The wheels of the central section are ideally non-steering, and the central section is adapted to carry a greater load than the first and/or second section of the haulage vehicle. For example, the central section may be adapted to carry between one-third and two-thirds of the total load of the vehicle. The central section may be adapted to carry 40-50% of the total load of the vehicle, with the remaining load being approximately split between the first and second sections of the haulage vehicle.

The vehicle may be adapted to carry a load exceeding its own net weight. More preferably, the vehicle is adapted to carry a load of at least 200% of its own net weight. Most preferably, the vehicle is adapted to carry a load of at least 250% of its own net weight.

Preferably, the vehicle includes a generator adapted to convert energy from motion into electric energy. The generator may be connectable to the drivetrain so as to generate electrical energy from vehicle movement, for example during a descent into a mine tunnel. The generator may be part of a “genset”, and may be powered by fuel. Ideally the fuel is a combustible fuel.

The vehicle may be specifically adapted to be bidirectional. For example, the powertrain of the vehicle (or components of it) may be arranged such that the vehicle has a maximum speed and/or power in a forward direction similar to that of a reverse direction. The maximum speed and/or power in the forward direction may be within 20% of that in the reverse direction. More preferably, the maximum speed and/or power in the forward direction may be within 90 to 100% of that in the reverse direction.

The vehicle may comprise a bidirectional lighting configuration. Preferably this is arranged to switch in dependence on the vehicle direction of travel. For example, if the vehicle is travelling with its first end facing the direction of travel, then the lighting configuration ideally illuminates front lights (such as headlights) at the first end, and rear lights (e.g. red-coloured lights) at the second end. Conversely, if the vehicle is travelling with its second end facing the direction of travel, then the lighting configuration ideally illuminates front lights (such as headlights) at the second end, and rear lights (e.g. red-coloured lights) at the first end.

Preferably, the vehicle includes a tub (or other suitable container) for carrying excavated material. The tub or similar may also be configured to carry other materials including water. The tub may be movably mounted and preferably drivable to offload excavated material from the vehicle. The vehicle may include a tub (or other suitable container) driving mechanism, such as a side tipper or a rear tipper, for driving the tub (or other suitable container) between a carrying configuration and an offloading or delivery configuration. The vehicle may include an exchange mechanism to switch between tubs (or other containers), for example between an empty tub and a full tub. The vehicle may include a water or utility carrying mechanism.

In the foregoing and hereinafter, reference is made to the vehicle including a “tub” for carrying excavated material. It will be understood that the term “tub” includes any suitable container, or similar, to carry excavated material or in fact other materials including liquid and semi liquid materials.

The vehicle may comprise a sensor set from which sensor data is generated, the sensor data representing the internal status of the vehicle and/or the environment within which the vehicle is operating in. The vehicle may comprise a communications system for communicating with a remote command system. Preferably, the vehicle communication system is arranged to transmit sensor data to the remote command system, and/or receive therefrom control instructions for controlling the operation of the vehicle. To this end, the vehicle comprises electronically-controllable actuators such as those controlling motor speed/power, braking, steering, lighting, suspension, load-balancing, roll stability, audible alerts, and the like.

By way of example, sensor data associated with the speed of the vehicle may be transmitted to the remote command system, and control instruction may be received from the command system to speed up or slow down the vehicle. Additionally, the vehicle may include an on-board control system which is arranged to autonomously control operation of the vehicle in response to the sensor data.

For example, the sensor set may include proximity or depth sensors for detecting the proximity of the vehicle relative to an external structure, such as a wall. In response to receiving proximity sensor data, the on-board control system may slow the vehicle down or stop the vehicle as it approaches a structure, and/or alter the trajectory of the vehicle. Accordingly, the on-board control system is communicatively linked to both the sensor set and vehicle actuators.

Advantageously, this can improve the responsiveness of vehicle control, especially for time-critical instructions such as collision avoidance, or when a communication link with a remote command system is adversely affected.

Actuators that control suspension, load-balancing and/or roll stability, preferably are controlled via the on-board control system in order to maximise stability of the vehicle whilst in transit, ideally in response to the control system receiving inputs from sensors of the sensor set such as those that signify orientation (e.g. pitch, roll, yaw). Such sensors are ideally mounted on different parts of the vehicle, especially those that may be moveable relative to the others. For example, the tub (or other container) may be moveable relative to an underlying chassis of the vehicle. Such movement may be controlled by the actuators. For example, if the vehicle is moving across uneven ground, with the left side of the vehicle lower than the right, it can be desirable to control the position of the tub (or other container) so that it shifts right relative to the underlying chassis of the vehicle. This can minimise the chance of the vehicle rolling over. A plurality of actuators may act between the tub and the underlying chassis, with the actuators being spaced from one another ideally so as to distribute the weight of the tub between them, with the spacing ideally accounting for their respective load-driving capabilities. For example, for four actuators having equal load-driving capabilities, it would generally be desirable to position them near to or at the periphery of the tub, with one actuator located at each corner (assuming a generally rectangular tub).

Furthermore, actuators that control suspension may be controlled via the on-board control system to adopt a crouch (or lowered) position in response to a need to lower the overall height of the vehicle. For example, this may be in response to being readied for loading where loading forces can be directed from the tub directly into the ground without admitting forces through the frame, suspension and wheels (tyres). This is ideally in response to inputs from sensors such as proximity sensors that indicate the size and shape of an opening through which the vehicle is to pass. Such sensors may register for example, that an approaching tunnel ceiling is low and in response, the actuators may be controlled to completely lower the tub to enable the vehicle to move along a path underneath the ceiling without risk of the tub, or a load carried by the tub coming into contact with the ceiling. This is particularly significant where there are changes in tunnel direction (e.g. up/down, left/right), and/or when the vehicle moves to one side when passing another mine asset. It will be understood that the crouch position will generally reduce suspension travel, and so, depending on detected ground conditions (e.g. rough, or smooth), the control system will also generally adapt other vehicle characteristics, such as speed to minimise damage to the vehicle.

The sensor set may include one or more camera type devices. The image feed from the or each camera device may be transmitted to the remote command system, and utilised by a remote operator to remotely pilot the vehicle. The image feed from the one or more camera devices may be fed to an artificial neural network for autonomous piloting (either on-board the vehicle, or via the communications system to the remote command system).

The image feed(s) may be utilised for various piloting functions, such as driving the vehicle, performing docking procedures, parking procedures, and/or actuating mechanisms such as those associated with the tub of the vehicle (e.g. a tub exchange procedure or tub loading or discharging procedures).

The sensor set may determine vehicle parameters, such as speed, acceleration, inclination, orientation, position, battery/fuel level, tub load, tub position, tub configuration and tyre pressure. Position sensors may comprise an inertial measurement unit and/or radio-localisation units.

The on-board control system may comprise a data logger, and be arranged to store data collected from sensors.

The on-board control system may also be arranged to communicate via a communication system with other mine assets, such as other mine vehicles. A communication system may include a combination of long-range and short-range transceivers, the former being used to communicate with the remote command system, and the latter to allow the vehicle to communicate directly with another mine asset that is physically close to the vehicle. For example, the vehicle may be arranged to communicate via the short-range transceiver with another mine asset to coordinate a procedure that requires precise control of the mine asset and vehicle. For example, where the other mine asset is another driverless haulage vehicle such as that according to the first aspect of the present invention, then a coordinate routine may be employed between them and may govern operation of each vehicle as they pass one another along a vehicle route.

Further optional features of the vehicle may be provided in the specific description below.

According to a second aspect of the present invention, there is provided an underground mining system. The system may comprise at least one of:
one or more driverless haulage vehicles according to the aforesaid first aspect of the present invention;
a remote command system for transmitting instructions to the or each said driverless haulage vehicle; and
a communication network arranged to communicatively link the remote command system to the or each said driverless haulage vehicle.

In accordance with yet another aspect of this invention, there is provided a driverless haulage vehicle for use with an underground mining operation, said driverless haulage vehicle including a unitary support chassis with a first end section, a second end section opposite said first end section and a central section located between said first end section and said second end section, haulage vehicle transport means including a first wheel assembly associated with and supporting said first end section of the unitary support chassis, a second wheel assembly associated with and support said second end section of the unitary support chassis, and a third wheel assembly associated with and supporting said central section of the unitary support chassis, said haulage vehicle transport means including steerage means operable for directing said driverless haulage vehicle along a transport drive path, and an electrically powered drive tran for driving said haulage vehicle transport means whereby said driverless haulage vehicle is remotely drivable along said transport drive path.

Conveniently, either of said first end section or said second section of said unitary support chassis is operationally selectable as a forward end of said driverless haulage vehicle for movement along said transport drive path.

Preferably the first wheel assembly includes a pair of spaced first wheel means with a first axle arrangement operationally connected thereto, said spaced first wheel means being selectably steerable by said storage means.

Preferably the second wheel assembly includes a pair of spaced second wheel means with a second axle arrangement operationally connected thereto, said spaced second wheel means being selectably steerable by said steerage means.

Conveniently, when the first wheel means are steered in a first direction by said steerage means, the second wheel means are steered in a second direction opposite to said first direction. Preferably, the third wheel assembly includes a pair of spaced third wheel means with a third axle arrangement connected thereto, the third wheel means being non-steerably mounted to said third axle arrangement.

In a preferred arrangement, at least one of the first wheel means, the second wheel means, and the third wheel means includes a single wheel hub structure carrying a pneumatically supported tyre. In a second preferred arrangement, at least one of the first wheel means, the second wheel means, and the third wheel means, may include at least two wheel hub structures, each carrying a separate pneumatically supported tyre. Such an arrangement may increase the load carrying capacity of the vehicle. Conveniently, each of the aforesaid tyres are designed for underground mine use.

The driverless haulage vehicle will desirably include a work platform structure carried by said unitary support chassis, said work platform structure having a vertical height adjustment capability to enable operational height variation relative to ground level. In a possible alternative preferred arrangement, the work platform structure may be movably adjustable in a lateral direction relative to said unitary support chassis to assist with load balancing.

In a further preferred arrangement, each of the aforesaid drivetrain sections may include an electric motor. In one configuration a said electric motor drives an axle operably associated with the wheels of each of said first, second and third sections. In another possible arrangement, a said electric motor may be provided to drive the or each said wheel of the first, second and third sections. Still alternatively various combinations of the aforesaid configurations are also possible. In a preferred configuration, the driverless haulage vehicle may further include an electrical energy generator adapted to convert energy from motion of said driverless haulage vehicle into electrical energy. Preferably, the electrical energy generator is also selectably driven by a generator drive motor. The generator drive motor, when provided might be a combustible fuel motor such as an internal combustion engine of any known design.

Conveniently, the driverless haulage vehicle has a maximum speed and/or power in a first direction with said first end section facing forwardly relative to said transport drive path that is between 80 to 100% of a maximum speed and/or power in a second direction with said second end section facing forwardly relative to said transport drive path.

Another preferred aspect may include providing a bidirectional lighting configuration arranged to switch in dependence on direction of travel of the driverless haulage vehicle.

As noted in the foregoing, the driverless haulage vehicle may include providing a work platform structure which may be a means for carrying excavated mine material (ore or the like) or for carrying other equipment, liquids, semi liquids, or materials as might be required within the mine environment. In each case, the work platform structure would be designed for its intended purpose. The principle use of such driverless haulage vehicles would be in the collection and removal of excavated mine material (ore or the like). In this aspect, the work platform structure may be a tub or container for receiving and carrying excavated mine material, said tub or container being drivable via a tub or container driving mechanism to offload the carried excavated mine material from the driverless haulage vehicle. In one preferred arrangement, it may also be desirable to provide a work platform structure exchange mechanism whereby differing work platform structures can be selectably positioned on the vehicle.

Conveniently, a driverless haulage vehicle as disclosed herein, may include:
(a) sensor set from which sensory data is generated, the sensor data representing internal status of the driverless haulage vehicle, and/or environmental status within which the driverless haulage vehicle is operating; and
(b) controllable actuators, controllable in response to sensor data from said sensor set.

In this preferred embodiment, the arrangement may include a communications system for communicating with a remote command system, the communications system being arranged to transmit the sensor data to the remote command system, and/or receive from said remote command system, control instructions for controlling operation of the driverless haulage vehicle via said controllable actuators. The controllable actuators may be arranged to control at least one of motor speed/power, braking, lighting, suspension load balancing, roll stability, and audible alerts.

According to a further aspect of the present invention, there is provided an underground mining system including at least one mining asset being a driverless haulage vehicle according to the aforesaid first aspect and at least one of:
(a) one or more mining assets, such as vehicles according to any preceding claim;
(b) vehicle charging and/or refueling points;
(c) a remote command system for transmitting instructions to mining assets, and/or receiving status reports from mining assets;
(d) a communications network, arranged to communicatively link the remote command system and/or mining assets to one another;
(e) ventilation and/or cooling system;
(f) an energy capture system, such as above-ground solar panels, the energy capture system being arranged to transfer captured power to mining assets;
(g) safety systems, such as fire suppression systems;
(h) traffic management systems;
(i) mine mapping systems; and
(j) mine asset tracking systems, for example for tracking and/or tagging personnel, equipment and vehicles.

The aforesaid underground mining system may include a ventilation and/or a cooling system.

Naturally, the components of the system are ideally arranged to interface with the vehicle according to the first aspect of the present invention in a way that improves the efficiency of excavated material extraction. By way of example, the system may comprise at least one excavation machine configured to extract material from an extremity of an underground mine. Preferably, the excavation machine is arranged to interface with one or more vehicles according to the first aspect of the present invention, such that extracted material can be passed directly into a vehicle tub. Advantageously, this minimises inefficient loading and offloading of excavated material.

By way of additional example, a remote command system may be arranged to track and control the position of mining assets within the underground mine. In particular, a positional map of the underground mine may be established by a remote command system, and the map may be divided into zones in dependence on the location of a mining asset such as an autonomous vehicle. This can be used to safely operate autonomous vehicles within a mine environment simultaneously with standard non-autonomous (manned) vehicles and other mining assets. In one example, the system determines a zone in front and/or behind a vehicle or other asset, typically along tunnel paths a predetermined distance, that acts as a buffer or separator. This can be used to keep autonomous vehicles away from manned vehicles (or other staff activities), or otherwise slow down or stop their approach. Whilst this is preferably controlled by a command system, it will be understood that redundancy and failsafe functions may be introduced, for example by waypoint transmitters within the tunnels (e.g. attached to the roof or wall of a mine tunnel). Such transmitters can directly communicate with the command system. If a manned vehicle wants to share the same path, it has to remain in the ‘gap’ between vehicle zones.

The present invention also anticipates providing an underground mining system for use in an underground mine including:
(a) one or more driverless haulage vehicles as described above and hereinafter; and
(b) a mining command system to determine:
   (i) a positional representation of the mine; and
   (ii) status data of the or each said driverless haulage vehicle, including position data of the or each said driverless haulage vehicle, to optimise delivery of excavated mine material to a delivery zone above ground.

Conveniently, the mining command system also determines status data of other assets located within the positional representation of the mine.

Still further, the present invention also anticipates providing an underground mining process including deploying at least one driverless haulage vehicle as described above and hereafter for movement along a transport drive path between a first zone being a delivery zone for mine excavation material located above ground and a second zone being an extraction zone located within an underground mine, said mine excavation material being carried from said second zone to said first zone by the same said driverless haulage vehicle. Conveniently, the aforesaid process will involve two or more said driverless haulage vehicles simultaneously operating along the transport drive path defined in part or wholly by underground tunnels within the underground mine, providing a remote command system for transmitting instructions to said driverless haulage vehicles, and/or receiving status reports from said driverless haulage vehicles, and providing a communications network arranged to communicatively link the network remote command system to said driverless haulage vehicles to enable free passage of said driverless haulage vehicles, either loaded or unloaded, between said first zone and said second zone.

According to a still further aspect of the present invention, there is provided an underground mining process. Ideally the process comprises deploying at least one of the components of the underground mining system according to the second aspect of the present invention to an underground mine, and controlling the operation and use of those components to optimise material excavation and extraction.

It will be understood that features and advantages of different aspects of the present invention may be combined or substituted with one another where context allows.

For example, the features of the vehicle and/or system described in relation to the first and/or second aspects of the present invention may be provided as part of the method described in relation to the third aspect of the present invention. Furthermore, such features may themselves constitute further aspects of the present invention.

By way of example, the process ideally comprises deploying a plurality of vehicles according to the first aspect of the present invention, the vehicles being configured and controlled to travel between a material extraction region of an underground mine at which said vehicles are loaded with extracted material, and a surface region at which the extracted material is off-loaded from the vehicles.

Additionally, isolated features and advantages of the specific description of the preferred embodiment, as will be described below, may be combined with aspects of the present invention.

### Specific Description of the Preferred Embodiments

In order for the invention to be more readily understood, embodiments of the invention will now be described and depicted, by way of example only.

### BRIEF DESCRIPTION OF THE DRAWINGS

FIG. 1 is a side elevation view of a first preferred embodiment of a driverless autonomous mine haulage vehicle for use in an underground mine;

FIG. 2 is a plan view of the embodiment illustrated in FIG. 1;

FIG. 3 is an underneath plan view of the embodiment illustrated in FIG. 1;

FIG. 4a is a perspective view of one end region of the vehicle shown in FIG. 1;

FIG. 4b is a detailed view of part of the vehicle illustrate in FIG. 4a;

FIG. 5a is a side elevation view of a second preferred embodiment of driverless autonomous mine haulage vehicle for use in an underground mine;

FIG. 5b is a side elevation view similar to FIG. 5a with portions removed to show underlying features with greater clarity;

FIG. 6 is an underneath plan view of the vehicle shown in FIG. 5a FIG. 7 is a perspective view of the vehicle show in in FIGS. 5a/5b;

FIG. 8a is a side elevation view of a vehicle similar to that shown in FIGS. 5a/5b but with a side tipping bin for unloading carried excavated mine material;

FIG. 8b is a perspective view of the vehicle shown in FIG. 8a;

FIG. 9a is a side elevation view of a vehicle similar to that shown in FIGS. 5a/5b but carrying a water tank as a possible alternative arrangement;

FIG. 9b is a perspective view of the vehicle show in in FIG. 9a;

FIG. 10a is a side elevation view of a vehicle similar to that shown in FIGS. 5a/5b but with a further possible alternative equipment carrying tray for use in an underground mine; and

FIG. 10b is a perspective view of the vehicle show in in FIG. 10a.

### DETAILED DESCRIPTION OF PREFERRED EMBODIMENTS

The annexed drawings illustrate various possible preferred embodiments of driverless autonomous haulage vehicles capable of use in tunnels of declines and drives of an underground mine, primarily but not exclusively, for removal of excavated mine material. While these vehicles are configured for use in an underground mine facility, there is no reason why the vehicles cannot also be used partially, or completely, above ground.

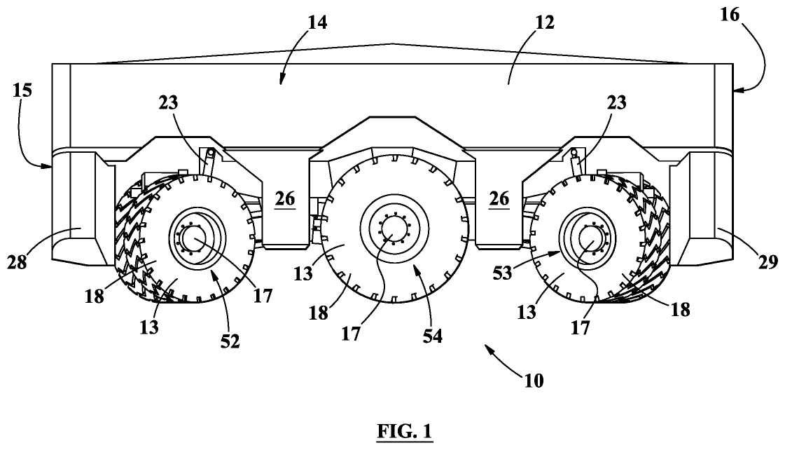

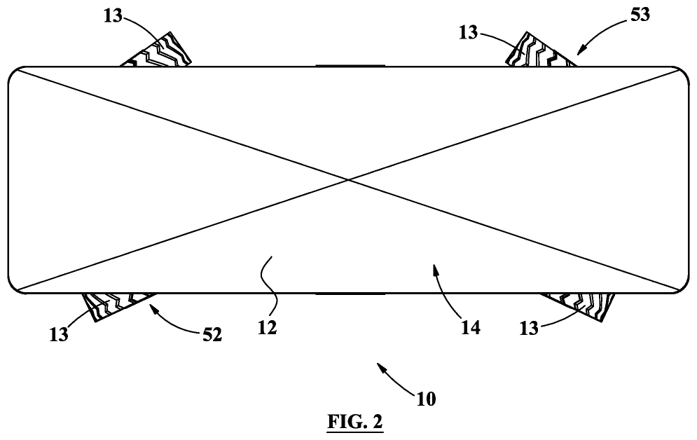

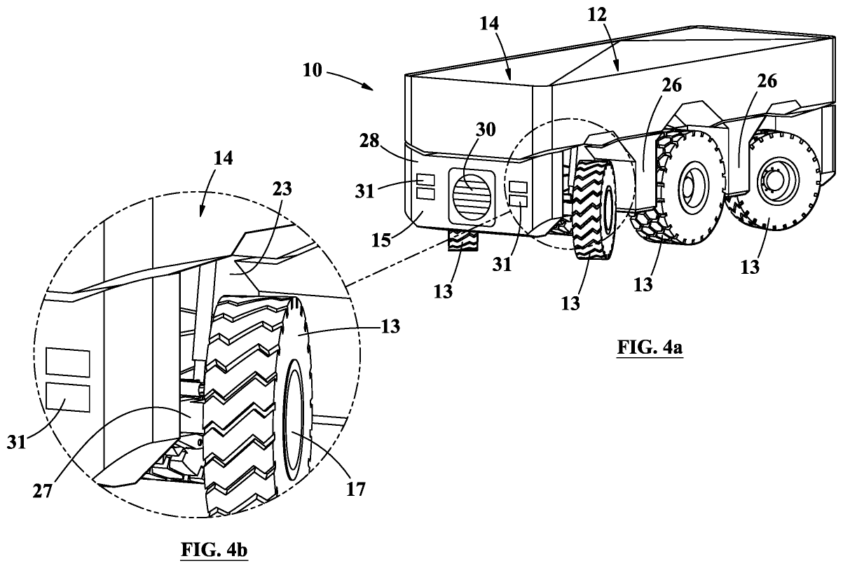

Referring first to FIGS. 1, 2, 3, 4a and 4b, a first preferred embodiment of an autonomous mine haulage vehicle 10 is illustrated having a unitary fabricated support chassis 11, an upper work platform structure 12 located above carried by the chassis 11, and spaced ground engaging support and transport wheels 13 operationally connected to the chassis 11. In this illustrated embodiment, the work platform structure 12 is configured as a container or tub 14 adapted to receive and carry excavated mine (ore or the like) material between desired operational zones within a mine facility. The container or tub 14 may include an upper cover structure or may be open as desired by the mine facility. The container or tub 14 may be mounted to side tip to the right or left of the vehicle 10 or may be mounted to tip towards the first end section 15 or the opposed second end section 16 of the vehicle 10 to allow excavated mine material to be discharged therefrom when desired. Conveniently, the wheels 13 each include at least one hub structure 17 with a pneumatically supported tyre structure 18 mounted thereon. The tyre structures 18 will be designed and rated for use in mine conditions. In the annexed drawings, each wheel 13 has a single hub and tyre structure 17, 18, however, if loading requirements are such, these structures can be configured as adjacent pairs of wheels 13. Each wheel (or pair of wheels) 13 are located at opposed ends of axle structures 19, 20, 21 extending laterally across the vehicle 10 with the axle structure 19 being located adjacent the first end section 15 of the vehicle and the axle structure 21 being located adjacent the second end section 16 of the vehicle. The axle structure 20 for the centrally located pare of wheels 13 is preferably located, as far as is possible, equal distances from the axle structures 19 and 21.

Preferably, a suitable suspension and support system 22 is provided between the work platform structure 12 and the axle structures 19, 20, 21. The suspension and support system may be hydraulically based and include hydraulic actuators 23, however, any other support and suspension system 22 might also be used.

Conveniently, each of the axle structures 19, 20, 21 are driven by motors 24, when actuated selectably, to drive the vehicle 10 either towards the first end section 15 direction or towards the second end section 16 direction. The motors 14 might preferably be electric motors powered by rechargeable batteries 25. It is, however, possible for any suitable internal combustion engine means to be provided to drive the axle structures. Still further it may well, in some instances, be possible for separate motors to be provided to drive each separate wheel 13 rather than the connecting axle structures.

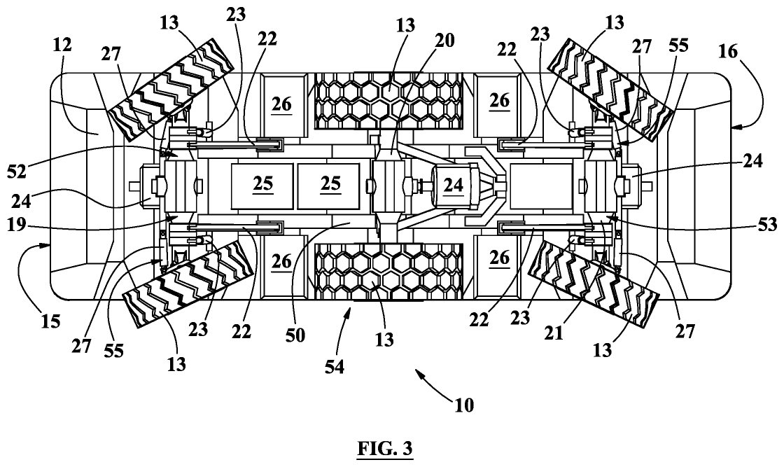

In the driverless haulage vehicle 10 illustrated, conveniently the wheels 13 and axle structure 19 form a first wheel assembly 52, with the wheels 13 and axle structure 21 forming a second wheel assembly 53. The wheels 13 and axle structure 20 form a third wheel assembly 54. The first wheel assembly 52 is located below and supports the first end section 15 with the second wheel assembly 53 being located below and supporting the second end section 16. A third wheel assembly 54 is located below and supports a central section 50 of the unitary vehicle chassis 11. Steerage means 55 is provided to enable the wheels 13 of at least the first wheel assembly 52 and the second wheel assembly 53. As is best seen in FIG. 3, the steerage means 55 includes actuators 27 whereby each of the wheel pairs 13 supporting the first end section 15 and the second end section 16 are steerable with the pairs of wheels 13 being steerably movable in opposite directions. Preferably the wheels 13 of the third wheel assembly 54 are not steerable.

As can be seen in FIG. 3, the actuators 27 can be independently operated whereby the angle of each wheel 13 in a pair of such wheels can be chosen to be located at selectable angles relative to each other to assist with cornering when desired. This is possible with the wheels 13 of each of the pairs of such wheels 13 operably mounted to axle arrangements 19, 21.

In a possible alternative arrangement, the axle structures 19, 21 might be mounted to provide steering movement rather than having the wheels 13 steerably more relative to the axles 19, 21.

The unitary chassis 11 may be fabricated from steel including tubular steel but the first, second and central sections 15,16 and 50 are not relatively articulated or movable relative to one another. Conveniently, the chassis 11 may also carry holding means 26 for spare or replaceable batteries which may be automatically switched to operative mode to drive motors 24 when the main batteries 25 are sufficiently depleted or discharged in use.

Each end of the vehicle 10 adjacent the respective first end 15 and the second end 16, may provide a housing structure 28, 29 for mounting various items including a generator or multiple generators, a motor for driving the or each generator when needed, cooling and/or ventilation equipment, and potentially air filtering equipment. The generator(s) can be operated by motion created by the downward movement of the vehicle 10 and supplemented by a drive motor such as an internal combustion engine. Air can be drawn into the cooling and or ventilation equipment via vent means 30 leading into the housing structure 28. Appropriate lighting means 31 might be provided at either the first end 15 and the second end 16 shining forwardly from the housing structures 28, 29. Conveniently tail (or reverse) lights may also be provided which are selectively activated depending on which end of 15 or 16 forms the trailing end of the vehicle when in use. The main directional lighting 31 at either end is selectably activated depending on direction movement of the vehicle 10.

Desirably, the vehicle 10 has a length up to but not exceeding 10 meters, a height of up to but not exceeding 3 meters and a width of up to but not exceeding 3 meters. Typically, the height of the vehicle is between 2 and 3 meters and its width is between 2 and 3 meters. Preferably, the length of the vehicle is less than 9.5 meters and is between 8 and 9.5 meters. The objective is for the vehicle to comfortably fit within the tunnel of a mine which commonly has a height of 4.5 meters and a width of 4 meters. It is also desirable that the vehicle be able to readily pass another similarly sized and configured vehicle when passing either up or down a typical decline. Declines in mines typically have a height of about 5.5 meters and a width of 5 meters, and may include one or more widened areas along the decline to allow the vehicles to pass.

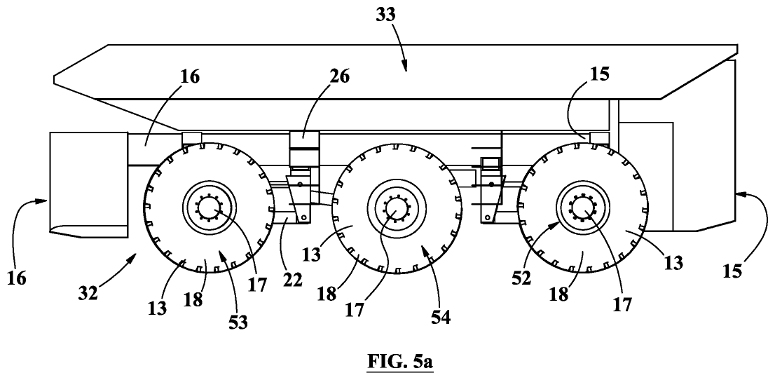

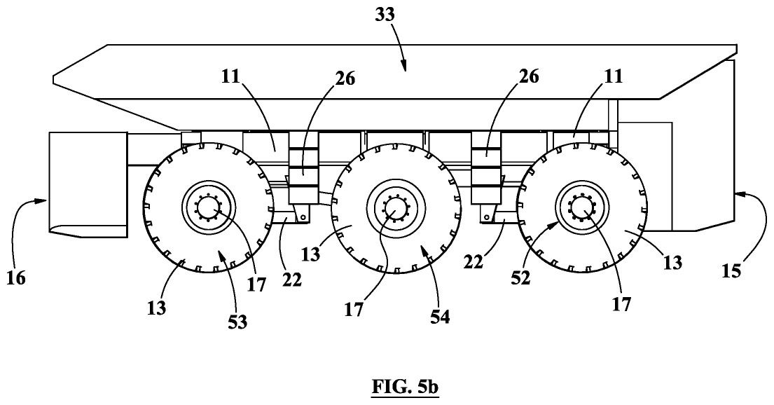

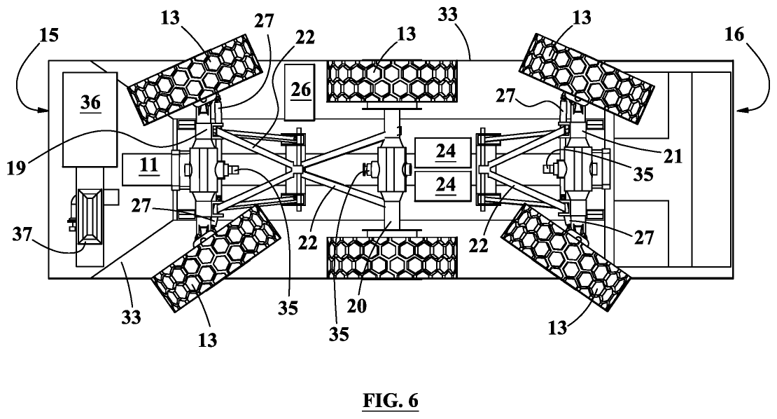

FIGS. 5a, 5b, 6 and 7 illustrate a similar mine haulage 32 to the vehicle 10 shown in earlier drawings, features of a similar nature and effect have been given the same reference numeral. Features illustrated and described in the earlier embodiment might also be included, if desired in this embodiment. In this embodiment, the work platform structure 12 may be an upwardly open bin or tub 33 carried by the vehicle chassis 11 where the excavated mine material (ore or the like) can be deposited into the bin or tub 33 at the position in the mine where it is dug, and can thereafter be moved either to the left or to the right (FIG. 5a/FIG. 5b), as required to move same to a delivery above or near surface ground level. The bin or tub 33 may be tipped about a lateral pivot axis to deposit the excavated material adjacent to the first end 15 or the second end 16, or about a longitudinal axis to tip the excavated material to either side of the vehicle 10. The driven axle assemblies 19, 20 and 21 for the wheels 13 are driven preferably by electric motors through drive connections 35, the motors not being illustrated for the sake of drawing clarity. Alternative drive means might also be utilised as with previously described embodiments. This embodiment may also include an electric power generator/motor set 36 conveniently located in the first end section 15 or optionally in both end sections 15, 16. FIG. 6 illustrates cooler and/or ventilation means 37 adapted to receive and operate on an air flow via the vent structure 30 in the end section 15. Lighting facilities 31 are provided as described in relation to the earlier embodiment.

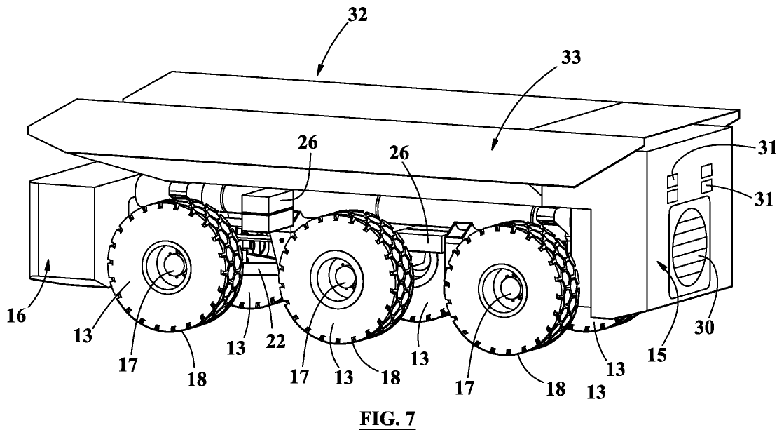

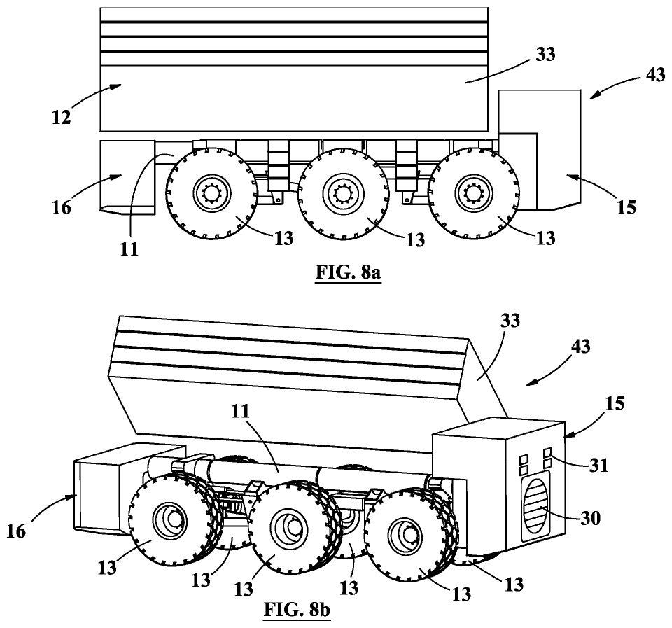

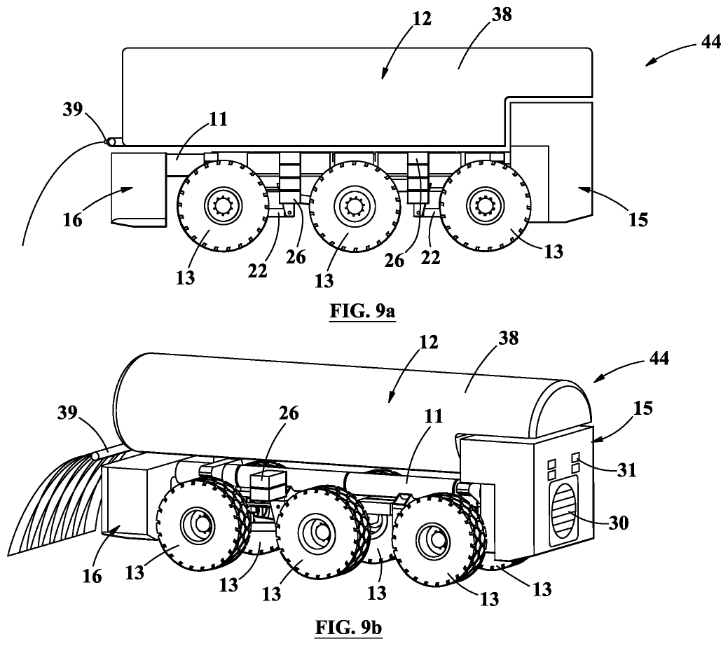

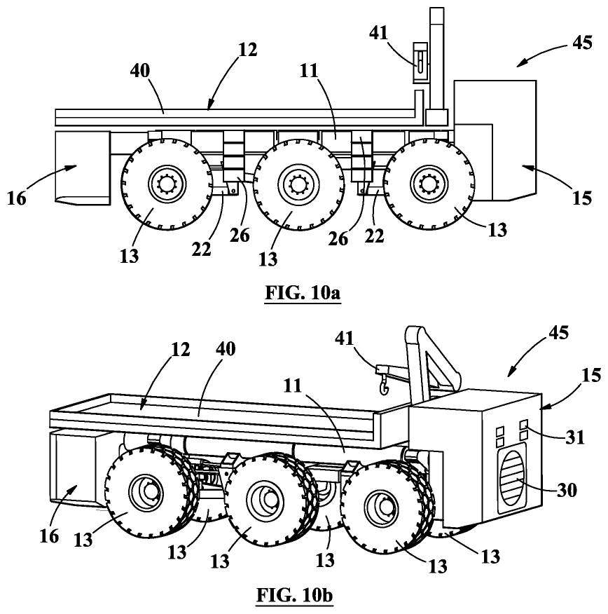

The preferred embodiment of FIGS. 8a/8b illustrate a possible vehicle 43 with a side tipping function of the bin or tub 33. The preferred embodiments of FIGS. 9a/9b illustrate a vehicle 44 with possible alternative work platform structure 12 being a tank facility 38 adapted to store, carry and/or dispense a liquid or semi liquid material. Typically, but not exclusively, the liquid might be water that can be discharged via a spray bar structure 39 located at the second end section 16. The preferred embodiment of FIGS. 10a/10b illustrate a vehicle 45 with yet another possible alternative work platform structure 12. In this embodiment, the work platform structure 12 comprises a carry tray 40 with a crane lifting assembly 41 to allow equipment or other material to be selectably lifted onto or off the carry tray 40. Apart from the above discussed variations, the vehicles 43, 44 and 45 may have the same features as those discussed in the preceding in relation to other preferred embodiments.

As is disclosed herein, the driverless haulage vehicle 10, 32, 43, 44 and 45 and associated systems and control apparatus, provide for efficient, safe and inexpensive recovery of mined excavation materials. The vehicle and system may include:
Electric Hybrid (series) drive (minimal transmission) which enables electric power to be used without driveshafts linking each axle through a transmission; this also saves space to enable a compact design;
3× electric motors with continuous 220 kW output power, 2000 Nm output torque each; enough power to enable loaded top speed up the decline; this results in a faster climbing speed than the current haulage technology;
Battery and genset powered; this enables a dual power unit to energise the vehicle;
24V DC control system; this enables the use of not only standard automotive electronic equipment but also standard industrial automation equipment;
Solar charging system integrated from top of mine; this can offset or even eliminate the need to have electricity supplied from the grid;
6 wheel drive, 3 solid/rigid planetary axles; the three axles allow for the 40 tonne (60 t GVM) payload and maximum traction for acceleration and braking; the planetary axles act as a reduction between the electric motors and wheels as well as reliably distributing torque minimising imbalance and causing stress concentrations in the drivetrain;
Secondary failsafe braking system (Spring applied hydraulically released brakes (SAHR), integrated wet disc brakes (service), parking brakes;
Brake lights on both ends of the vehicle, indicator lights to show mode of operation and audible warnings;
Direct drive mechanism, electric motors mounted or integrated into axles in either colinear parallel or through right angle gear train; eliminate the need for drive shafts to improve efficiency and reliability due to fewer moving parts;
Centre axle wheels may be double wheels each side, or may be increased capacity single tyres with change in dimension of both height and width to match weight distribution of 30% from both outer axles (18 tonne each axle) and 40% inner axle (24 tonne). This arrangement of axles enables a bidirectional vehicle that can perform the same in either direction, eliminates the need to turn around in narrow sections—it simply reverses out (similar to the motion of a locomotive). There are no known operational vehicles that can do this and haul ore. As a result mines have to be designed to cater for large turning circles or use other equipment to compensate, adding to energy and time wastage;
Cut outs in “tub” to allow for larger wheels/tyres;
Tub options are rear tip, side tip water carriage, utility tray or roll on/roll off tub exchange system from chassis for changeover in limited space. The benefit of this is flexibility to suit a mine's characteristics, the roll on/roll off system allows an exchange of tubs in tight places and also has the benefit of having the loading equipment being utilised 100% of the time without having to stop operations;
Tub material high tensile steel, approx. 18 to 22 m³ volume tub;
Smallest footprint possible to pass same vehicle on 5 m wide×5.5 m high decline; this improves process balance and simplifies traffic management, especially when demand increases, and more volume is required to haul;
40 t payload, approx. 60 t GVM; a payload to net mass ratio of approx. 2 (40 t/20 t=2:1), emphasising minimum vehicle mass to haul a maximum payload; this directly improves efficiency and saves energy; current haulage vehicles have an approx. ratio of 1.5:1 which is a less efficient design;
Top speed 18-20 km/hr, loaded, up a 1 in 7 decline. A higher return velocity (loaded) results in reduced cycle time and balanced process ultimately saving time. Most of the current haulage technology cannot reach this speed and therefore cycle times are longer and by default create process balance—time down decline vs time up the decline;
Automated guided vehicle (AGV) with remote control capabilities. This saves on cost of labour, eliminates human error due to fatigue, and allows the vehicle to enter tighter spaces due to not needing a cabin to house an operator. It allows dangerous areas to be accessed without putting lives at risk. The remote control capability allows the main control room or an operator in the mine to control the vehicle from anywhere in the mine, allowing an automated vehicle into an area which may be occupied by people or manual equipment. It also has the benefit of operating a vehicle in an area that hasn't been installed with infrastructure to guide the vehicle autonomously;
4 wheel steering on outer axles. This enables a very tight turning circle and capability of maneuvers in a 4 m wide×4.5 high drive around 85° corners, allowing access into tight places as a hauling vehicle;
Comparable CAPEX cost to current 60 t capacity (105 t GVM) haulage truck (approx. $1.8 m AUD);
Batteries are mounted as low as possible to improve center of gravity, handling and stability. The narrowness and payload net-mass-ratio of this vehicle requires as low a center of gravity as possible, especially as the batteries will make up a sizable portion of the net mass and they need to be located as low as possible;
The aim is to have interchangeable parts that can be easily upgraded as technology such as batteries and generators improves. To achieve this the vehicle is made from off the shelf items, reducing vehicle development time to a minimum. and disrupting one-supplier cost inefficiencies of many OEM's;
Hydraulic, computer-controlled suspension, level sensing and levelling along or square to drive direction, remote angle adjustments, independent cylinder control, controls load distribution, data logged and real time monitoring/control through traffic management system, adjustable height settings, load measuring, roll stabilisation. In order to keep the vehicle stable it needs an advanced suspension system that is both flexible and robust—the payload to net-mass-ratio will cause inherent stability issues that need to be overcome with this type of control. Another benefit of this system is the capacity for varying ride heights depending on the headspace and/or terrain (it will be possible to lift the vehicle to a higher driving position over rough terrain and a lower position for low head space areas). Current haulage technology lacks sophisticated suspension as a trade off for payload capacity and does not have the flexibility to decrease its head height when needed;
LiFePO₄ or NMC battery technology;
Standard vehicle fitted with 400 kWh of batteries+maximum 280 kW (constant) generator for charging, Optional additional 200 kWh batteries and smaller generators, modular design (this modular approach allows the vehicle to be customised depending on the mines characteristics). If there is a long haul then the customer can increase battery and charging capacity OR if there is a short haul the customer can reduce costs by having only what is needed. As the mine gets deeper the customer can add capability and minimise energy usage
Approx. vehicle dimensions 2.8 m wide, 8.9 m long, 2.5 m high in crouch position, 3 m high in upper position; these dimensions allow maneuvering around 85° bends in a 4.5 m wide×5 m high drive;
Integrated traffic management software and hardware, route planning/scheduling/optimisation, multi vehicle control, collision avoidance and coordination system, digital software based mine mapping system integrating all vehicles. This is a control system that ultimately tracks and controls the vehicles whilst in autonomous mode and allows the entire mine to operate as one system rather than fragmented parts;
Redundant safety systems (both wireless and hardwired) enable the fleet to be shutdown in an emergency;
Integrated high speed network and wireless system in mine for vision, communications and control;
Charging points with automatic docking, distributed along haulage length. To mimic a fragmented conveyor the vehicles need to stop in situ in the mine at the end of a hauling shift. This enables process balance but also a place for the vehicle to charge—designated docking points that the vehicle can drive near and automatically connect to the grid and charge the onboard batteries;
Wireless shutdown, low latency safety monitoring controlling normally open contacts to shut down the vehicle, physical bumpstops for E-Stop, optical safety scanners, vision system to analyse moving targets and change in environment.
Remote and manual override to remote control;
Multi redundant AGV system using laser, camera, radar, sonar, thermal inertial navigation and 3D scanning technology, vehicle management system controlling acceleration, braking, steering, direction with communications to a control;
Approximate inside turning circle under low speed 2.8 m, outside turning circle 6.5 m, with the aim of matching or improving maneuverability of the LHD loading vehicle to fit in the same dimensioned drive (tunnel) with the capability of maneuvering 85° bends within a 4.5 m high×4 m wide drive;
Bidirectional performance. The vehicle won't need to turn around in tight places which would otherwise restrict access and process flexibility;
Mine safety layout to isolate personnel away from main decline and any levels/drives undergoing haulage operation, physical barriers (concrete/metal etc) and sensory devices (safety scanners and cameras) may be used at each entrance to stop automated vehicle from entering the same area as personnel, sensory devices and cameras to be in communication with the control/management system directly linked to low latency monitored shut-off system;
If haulage is interrupted by manual equipment/vehicle or personnel proximity then the mine is sectioned into safety zones;
Real time tracking and tagging system fitted to personnel, equipment and vehicles to determine location within mine and integrated into control/management system. The same system utilises geofencing, collision detection, alarms/alerts, all with data-logging capabilities;
Roll off/roll on maintenance designated AGV allows for transport of equipment and supplies to and from above-ground without interrupting haulage convoy, to be operated via remote when within human reach. This system allows the haulage convoy to continue operation without stoppages but also underground crews to remain well supplied at any time. May be fitted with automatic fire suppression system in case of fire.

Although the invention has been described in conjunction with specific preferred embodiments, it will be evident that many alternatives, modifications and variations will be apparent to those skilled in the art. Accordingly, it is intended to embrace all such alternatives, modifications and variations that fall within the scope of the appended claims.

1. A driverless haulage vehicle for use with an underground mining operation, said vehicle including support and transport means including an electrically powered drivetrain, said electrically powered drivetrain having at least one electric motor.

2. A driverless haulage vehicle according to claim 1, wherein the drivetrain includes three sections, a first section being located towards a first end of the driverless haulage vehicle, a second section being located towards a second end of the driverless haulage vehicle opposite to said first end, and a central section being located between said first section and said second section.

3. A driverless haulage vehicle according to claim 2, wherein each said drivetrain section is driven by at least one said electric motor.

4. A driverless haulage vehicle according to claim 2, wherein wheels of the first section and the second section of said drivetrain are movable by steerage linkages, with the wheels of said first section being arranged to be moved during a corner-turning operation in an opposite orientation to the wheels of the second section whereby a turning circle of the driverless haulage vehicle is reduced.

5. A driverless haulage vehicle according to claim 4, wherein wheels of the central section of the drivetrain are non-steering.

6. A driverless haulage vehicle according to claim 5, wherein the central section of the drivetrain is configured to carry a greater load than the first section and/or second section of the drivetrain.

7. A driverless haulage vehicle for use with an underground mining operation, said driverless haulage vehicle including a unitary support chassis with a first end section, a second end section opposite said first end section and a central section located between said first end section and said second end section, haulage vehicle transport means including a first wheel assembly associated with and supporting said first end section of the unitary support chassis, a second wheel assembly associated with and support said second end section of the unitary support chassis, and a third wheel assembly associated with and supporting said central section of the unitary support chassis, said haulage vehicle transport means including steerage means operable for directing said driverless haulage vehicle along a transport drive path, and an electrically powered drive train for driving said haulage vehicle transport means whereby said driverless haulage vehicle is remotely drivable along said transport drive path.

8. A driverless haulage vehicle according to claim 7, wherein either of said first end section or said second end section of said unitary support chassis is operationally selectable as a forward end of said driverless haulage vehicle for movement along said transport drive path.

9. A driverless haulage vehicle according to claim 7, wherein said first wheel assembly includes a pair of spaced first wheel means with a first axle arrangement operationally connected thereto, said spaced first wheel means being selectably steerable by said steerage means.

10. A driverless haulage vehicle according to claim 7, wherein said second wheel assembly includes a pair of spaced second wheel means with a second axle arrangement operationally connected thereto, said spaced second wheel means being selectably steerable by said steerage means.

11. A driverless haulage vehicle according to claim 10, wherein said first wheel means are steered in a first direction by said steerage means, said second wheel means are steered in a second direction opposite to said first direction.

12. A driverless haulage vehicle according to claim 9, wherein said pair of spaced wheel means are independently steered relative to said first axle arrangement and to each other.

13. A driverless haulage vehicle according to claim 10, wherein said pair of spaced wheel means are independently steered relative to said second axle arrangement and to each other.

14. A driverless haulage vehicle according to claim 1 wherein the third wheel assembly includes a pair of spaced third wheel means with a third axle arrangement connected thereto, said third wheel means being non-steerably mounted to said third axle arrangement.

15. A driverless haulage vehicle according to claim 9, wherein at least one of the first wheel means, the second wheel means, and the third wheel means includes a single wheel hub structure carrying a pneumatically supported tyre.

16. A driverless haulage vehicle according to claim 9, wherein at least one of the first wheel means, the second wheel means and the third wheel means includes at least two wheel hub structures each carrying a separate pneumatically supported tyre.

17. A driverless haulage vehicle according to claim 7, further including a work platform structure carried by said unitary support chassis, said work platform structure having a vertical height adjustment capability to enable operational height variation relative to ground level.

18. A driverless haulage vehicle according to claim 7, wherein said work platform structure is movably adjustable in a lateral direction relative to said unitary support chassis to assist with load balancing.

19. A driverless haulage vehicle according to claim 1 further including an electrical energy generator adapted to convert energy from motion of said driverless haulage vehicle into electrical energy.

20. A driverless haulage vehicle according to claim 17, wherein the electrical energy generator is also selectably driven by a generator drive motor.

21. A driverless haulage vehicle according to claim 7, wherein the driverless haulage vehicle has a maximum speed and/or power in a first direction with said first end section facing forwardly relative to said transport drive path that is between 80 to 100% of a maximum speed and/or power in a second direction with said second end section facing forwardly relative to said transport drive path.

22. A driverless haulage vehicle according to claim 1 further including a bidirectional lighting configuration arranged to switch in dependence on direction of travel of the driverless haulage vehicle.

23. A driverless haulage vehicle according to claim 1 further including a work platform structure.

24. A driverless haulage vehicle according to claim 23, wherein said work platform structure is a tub or container for receiving and carrying excavated mine material, said tub or container being drivable via a tub or container driving mechanism to offload the carried excavated mine material from the driverless haulage vehicle.

25. A driverless haulage vehicle according to claim 24, wherein said work platform structure is a container configured to carry and/or dispense water or other liquid materials.

26. A driverless haulage vehicle according to claim 23, further including a work platform structure exchange mechanism.

27. A driverless haulage vehicle according to claim 1, further including:
(a) a sensor set from which sensory data is generated, the sensor data representing internal status of the driverless haulage vehicle, and/or environmental status within which the driverless haulage vehicle is operating; and
(b) controllable actuators, controllable in response to sensor data from said sensor set.

28. A driverless haulage vehicle according to claim 27, further including a communications system for communicating with a remote command system, the communications system being arranged to transmit the sensor data to the remote command system, and/or receive from said remote command system, control instructions for controlling operation of the driverless haulage vehicle via said controllable actuators.

29. A driverless haulage vehicle according to claim 1 having a height no greater than 3 meters, a width of no greater than 3 meters and a length of no greater than 10 meters.

30. A driverless haulage vehicle according to claim 29, wherein the height is between 2 and 3 meters, the width is between 2 and 3 meters and the length is between 6 and 10 meters.

31. A driverless haulage vehicle according to claim 30 wherein the length is no greater than 9.5 meters.

32. A driverless haulage vehicle for use with an underground mining operation, said vehicle including a unitary support chassis having a first end section, a second end section and a central section located between said first and said second end sections, haulage vehicle transport means including a first wheel assembly associated with and supporting the first end section, a second wheel assembly associated with and supporting said second end section of the unitary support chassis, and a third wheel assembly associated with and supporting the central section of the unitary support chassis, steerage means carried on said driverless haulage vehicle for directing said vehicle along a transport path with an underground mine, the steerage means including said first wheel assembly and said second wheel assembly, said steerage means further including a sensor set from which sensor data is generated representing internal status of the driverless haulage vehicle, and/or environmental status within which the driverless haulage vehicle is operating, and controllable actuators to control steering movements of said first wheel assembly and said second wheel assembly whereby during steering, wheels of the first wheel assembly are directed oppositely to wheels of the second wheel assembly.

33. An underground mining system for use in an underground mine including:
(a) one or more driverless haulage vehicles according to claim 1; and
(b) a mining command system to determine:
(i) a positional representation of the mine; and
(ii) status data of the or each said driverless haulage vehicle, including position data of the or each said driverless haulage vehicle, to optimise delivery of excavated mine material to a delivery zone above ground.

34. An underground mining system according to claim 33, wherein the mining command system also determines status data of other assets located within the positional representation of the mine.

35. An underground mining process including deploying at least one driverless haulage vehicle according to claim 1 for movement along a transport drive path between a first zone being a delivery zone for mine excavation material located above ground and a second zone being an extraction zone located within an underground mine, said mine excavation material being carried from said second zone to said first zone by the same said driverless haulage vehicle.

36. An underground mining process according to claim 35 involving two or more said driverless haulage vehicles simultaneously operating along the transport drive path defined in part or wholly by underground tunnels within the underground mine, providing a remote command system for transmitting instructions to said driverless haulage vehicles, and/or receiving status reports from said driverless haulage vehicles, and providing a communications network arranged to communicatively link the network remote command system to said driverless haulage vehicles, to enable free passage of said driverless haulage vehicles, either loaded or unloaded, between said first zone and said second zone.
